(19) United States
(12) Patent Application Publication
(10) Pub. No.: US 2008/0099134 A1
(43) Pub. Date: May 1, 2008

(54) Method for fixing plastic substrate, circuit substrate and method for producing same

(75) Inventor: Yoshio Tadakuma, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/723,327

(22) Filed: Mar. 19, 2007

(30) Foreign Application Priority Data
Mar. 20, 2006 (JP) 2006-075975

(51) Int. Cl. B32B 37/02

(52) U.S. Cl. 156/250; 156/272.2; 156/272.6; 156/285

(57) ABSTRACT

A method for fixing a plastic substrate, comprising (1) applying or sticking an adhesive material onto a supporting substrate to form an adhesive material layer on the supporting substrate, (2) applying selective adhesive strength controlling treatment to the adhesive material layer to form at least two regions of a low adhesive strength region and a high adhesive strength region, and (3) applying under pressure a plastic substrate to the adhesive material layer at most 300 Torr.

### BACKGROUND OF THE INVENTION

1. Field of the Invention

The present invention relates to a plastic substrate and to a method for producing a circuit substrate. Concretely, the invention relates to a method for producing a thin-film laminate device comprising a plastic substrate, and a liquid-crystal display device, in particular to a method for producing various thin-film laminate devices such as flat panel displays (FPD), for example, a liquid-crystal display device with a circuit pattern formed on a plastic film, an organic EL display device, a plasma display panel (PDP), an electrochromic display device, an electroluminescent display device, a field emission display device (FED), etc.; as well as various sensors such as two-dimensional image detectors, and print wiring boards.

2. Description of the Related Art

Heretofore, it has been investigated to thin a substrate for the purpose of reducing the weight of flat panel displays such as typically liquid-crystal display devices, and at present, liquid-crystal display devices are fabricated using a glass substrate having a thickness of from 0.5 mm to 1.1 mm or so. However, when a glass substrate thinner than it is used, then it has a problem in that it may be readily cracked while produced or used. As one method for solving the problem, a liquid-crystal display device comprising a plastic substrate in place of a glass substrate is being developed.

Regarding production of a plastic substrate, for example, JP-A-3-5718 discloses a method of fabricating a liquid-crystal display device while a sheet-like plastic substrate is conveyed by itself or while a rolled plastic substrate is continuously fed out. However, because of various problems in that a plastic substrate is not rigid and is not tough, its thermal deformation temperature is low, its surface hardness is low and its surface is therefore readily scratched, and it readily undergoes deformation such as warping or thermal expansion or contraction in a heating step, the production of liquid-crystal display devices with such a plastic substrate is much more difficult than the production thereof with a glass substrate both in the case where the plastic substrate alone is conveyed by itself and in the case where the rolled plastic substrate is fed out.

Given that condition, for example, JP-A-60-41018 discloses a method for producing a liquid-crystal display device wherein a plastic substrate as fixed in a frame is conveyed. However, in the production method where a plastic substrate is fixed in a frame and conveyed, the plastic substrate may be warped inside the frame and it could hardly keep its surface flatness. Accordingly, in various units for the production of a liquid-crystal display device, there may be a problem in that an auxiliary member to assist the flatness of the frame inside it would be needed, and for example, the frame must be specifically planned to have a special stage-like configuration by itself.

JP-A-58-147713 proposes a production method wherein a plastic substrate is fixed through fusion at its periphery and then the fused part is cut off. However, the method is limited only to a case where the support to which the plastic substrate is fixed is formed of a plastic film thicker than the plastic substrate, and in this, any other support having better conveyance stability such as glass could not be used.

JP-A-8-86993 proposes a method of producing a liquid-crystal display device (active matrix substrate and counter substrate), that comprises providing an adhesive material layer having an adhesive power to such a degree that the layer is repeatedly desorbable, on the entire surface of a supporting substrate and a plastic substrate is stuck thereto. According to this method, after an active matrix substrate or the like has been produced, the active matrix substrate or the counter substrate is peeled from the supporting substrate by the use of a component. After this, the method comprises a step of sticking the active matrix substrate and the counter substrate, a step of cutting it, a step of injecting a liquid crystal into it, and a step of sealing up it, thereby producing a finished liquid-crystal display device. However, even when such a supporting substrate that has the adhesive power given uniformly to its surface is used, it is extremely difficult to realize the trade-off adhesiveness of the supporting substrate of such that the plastic substrate stuck to it does not peel off during the production process and the plastic substrate can be smoothly peeled away from the supporting substrate after the production process. In addition, since the two substrates are not fixed in vacuum, they may contain invisible minor bubbles inside them, and therefore, at in a high-temperature and high vacuum step, the bubbles may expand to cause surface roughness of the substrates, and in a serious case, the substrates may be peeled off. Accordingly, the temperature applicable to the method is at most 150° C. or so, and the temperature range is too low to produce high-performance thin-film laminate devices.

JP-A-2002-72905 proposes a method for producing a liquid-crystal display device, which comprises uniformly applying a resin material onto a supporting substrate to form a plastic substrate thereon, then an active matrix substrate and a counter substrate are separately laminated on the plastic substrate, and they are stuck together, and thereafter the supporting substrate is removed by etching. According to the method, a plastic substrate is formed by uniformly applying a resin material onto a supporting substrate. Therefore, the method has the same problem as that in JP-A-8-86993. JP-A-2002-72905 further proposes a technique of providing an interlayer such as an etching stopping layer between the supporting substrate and the plastic substrate, but this does not propose a technique of providing an adhesive material layer as the interlayer.

### SUMMARY OF THE INVENTION

In consideration of the above-mentioned problems in the related art, the present invention is to provide a technique of working a plastic substrate of which the strength and the toughness are poor by itself, into a circuit substrate in a simplified manner.

We, the present inventors have assiduously studied and, as a result, have found that the above-mentioned problems can be solved by the following means [1] to [9]:

[1] A method for fixing a plastic substrate, comprising:

applying or sticking an adhesive material onto a supporting substrate to thereby form an adhesive material layer on the supporting substrate (first step),

applying selective adhesive strength controlling treatment to the adhesive material layer to thereby form, in the adhesive material layer, at least two regions of a low adhesive strength region and a high adhesive strength region of which the adhesive strength is higher than that of the low adhesive strength region (second step), and

applying under pressure a plastic substrate to the adhesive material layer having the plural adhesive strength regions provided therein, in an atmosphere having a vacuum degree of at most 300 Torr (third step).

[2] The method for fixing a plastic substrate of [1], wherein the adhesive strength of the low adhesive strength region is from 0.01 to 0.4 newtons.

[3] The method for fixing a plastic substrate of [1] or [2], wherein the adhesive strength of the high adhesive strength region is at least 0.5 newtons.

[4] The method for fixing a plastic substrate of any one of [1] to [3], wherein the adhesive strength controlling treatment in the above second step is at least one selected from a group consisting of oxygen plasma treatment, ozone treatment and UV ray irradiation treatment.

[5] The method for fixing a plastic substrate of any one of [1] to [4], wherein the high adhesive strength region is disposed in the peripheral region of the supporting substrate.

[6] The method for fixing a plastic substrate of any one of [1] to [5], wherein the low adhesive strength region is disposed in the center part except the peripheral region of the supporting substrate.

[7] The method for fixing a plastic substrate of any one of [1] to [6], wherein the vacuum degree in the above third step is at most 30 Torr.

[8] A fixed plastic substrate produced by the method of any one of [1] to [7].

[9] A method for producing a circuit substrate, comprising:

applying or sticking an adhesive material onto a supporting substrate to thereby form an adhesive material layer on the supporting substrate (first step),

applying selective adhesive strength controlling treatment to the adhesive material layer to thereby form, in the adhesive material layer, at least two regions of a low adhesive strength region and a high adhesive strength region of which the adhesive strength is higher than that of the low adhesive strength region (second step),

applying under pressure a plastic substrate to the adhesive material layer having the plural adhesive strength regions provided therein, in an atmosphere having a vacuum degree of at most 300 Torr (third step),

forming a circuit in a region of the surface of the plastic substrate opposite to the face thereof adhered to the adhesive material layer and corresponding to the area just above the low adhesive strength region (fourth step), and

cutting out the region of the plastic substrate having the circuit formed thereon, as released from the low adhesive strength region of the adhesive material layer serving as a release layer, thereby producing a circuit substrate having a circuit on the plastic substrate (fifth step).

[10] A circuit substrate produced according to the production method of [9].

In the invention, a plastic substrate is fixed by applying or sticking an adhesive material to a supporting substrate, and therefore, even a plastic substrate of which the strength and the toughness are poor by itself can be used in fabricating a thin-layer laminate device. In the invention, the adhesive strength in the peripheral part where a thin-film laminate device is not formed is high, and the center part where the device is formed is low, and therefore, a trouble of film delamination can be prevented throughout the process and the device can be smoothly cut out not detracting from the properties of the device. Further, in the invention, when a plastic substrate is fixed to the adhesive material layer-coated supporting substrate, the two are kept under pressure in a vacuum condition of at most 300 Torr, and therefore no bubble may enter the interface between the bonding two. Accordingly, in the invention, the bonding pressure may be lower than that in a case of bonding in air, and in addition, the damage to the surface of the plastic substrate may be reduced and the film delamination does not occur even in a high temperature and high vacuum condition, and the invention enables production of high-performance thin-film laminate devices.

### BRIEF DESCRIPTION OF THE DRAWINGS

FIG. 1 is a top view of a plastic substrate fitted to a fixing component according to the invention, showing the adhesive strength distribution of the adhesive material applied to the component and the position at which the plastic substrate is cut off.

FIG. 2 is a structural cross-sectional view of the plastic substrate fitted to a fixing component according to the invention, showing the adhesive strength distribution of the adhesive material applied to the component and the position at which the plastic substrate is cut off.

In the drawings, 1 is a high adhesive strength region; 2 is a low adhesive strength region (a thin-film laminate device forming region); 3 is a cutting position of a plastic substrate; 4 is a plastic substrate; 5 is an adhesive material; 6 is a supporting substrate.

### BEST MODE FOR CARRYING OUT THE INVENTION

The method for fixing a plastic substrate of the invention is described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

### Constitutive Materials:

The supporting substrate in the invention is a tough substrate on which a plastic substrate is fixed with an adhesive material. In the entire process comprising fixing the plastic substrate thereon, the forming a device on it, and cutting off the plastic substrate from it, the supporting substrate shall protect the plastic substrate from deformation and delamination by various factors, thereby ensuring smooth operation of the process. The supporting substrate of the type includes glass substrates, silicon wafers, thick plastic substrates, but its materials are not specifically defined so far as they have no problem in point of their heat resistance, chemical resistance, pressure resistance, light resistance. Not specifically defined, the thickness of the supporting substrate may be generally from 10 μm to 1 mm, preferably from 25 μm to 750 μm, more preferably from 50 μm to 500 μm.

The materials for the plastic substrate in the invention are not specifically defined so far as they have good heat resistance, chemical resistance, pressure resistance and light resistance durable to the process of forming a thin-film laminate device thereon. On one face or on both faces thereof, the substrate may be laminated with a thin film of an organic film alone, an inorganic film alone, or an organic/inorganic composite film. The material to constitute the plastic substrate is, for example, a polyethylene terephthalate film, a polyether sulfone film or a polyimide film.

The adhesive material in the invention is meant to indicate a material of such that, when a supporting substrate and a plastic substrate are conveyed while they are bonded to each other via it in a device production process, the adhesive material may ensure a satisfactory adhesive strength to both the supporting substrate and the plastic substrate and that, in addition, after the device production process, the plastic substrate may be readily released from the supporting substrate. The adhesive material that enables such temporary adhesion and peeling includes silicone rubber, butyl rubber, urethane rubber, natural rubber, butadiene rubber, nitrile rubber, acryl rubber, fluorine rubber. Of those, preferred are silicone rubber and butyl rubber in consideration of their adhesiveness, heat resistance, chemical resistance, surface smoothness and light resistance.

### First Step:

In the method for fixing a plastic substrate of the invention, the first step comprises applying or sticking an adhesive material to a supporting substrate, thereby forming an adhesive material layer on the supporting substrate. In this description, the component prepared by applying or sticking an adhesive material to a supporting substrate is referred to as a fixing component.

The adhesive material layer may be formed by sticking a sheet-like adhesive material onto a supporting substrate, or may be formed by applying a liquid monomer and then polymerizing it optionally by heat treatment or UV irradiation treatment to thereby make the substrate have an adhesive strength. The forming method may be suitably selected depending on the adhesive strength necessary for fixing the supporting substrate and a plastic substrate thereto and on the shape of the supporting substrate.

In the first step of the invention, an adhesive material layer is formed in at least the entire region where a plastic substrate is to be stuck to the supporting substrate in the third step. So far as it satisfies this condition, the adhesive material layer-forming region may cover the entire surface of the supporting substrate, or may be a part thereof.

### Second Step:

In the method for fixing a plastic substrate of the invention, the second step comprises applying selective adhesive strength controlling treatment to the adhesive material layer to thereby form, in the adhesive material layer, at least two regions of a low adhesive strength region and a high adhesive strength region of which the adhesive strength is higher than that of the low adhesive strength region.

The adhesive strength varies depending on the material, the thickness and the surface condition of the supporting substrate and the plastic substrate and on the condition in the conveyance step; and therefore, the adhesive strength must be controlled each time in order that the adhesiveness between the supporting substrate and the plastic substrate could be the best all the time. The adhesive strength as referred to herein means as follows: Using a test sample of a plastic substrate with a 20-mm strip-like adhesive material applied thereto, the bonded films are peeled off from one end according to a 180-degree peeling method, and the peeling force (newton) is the adhesive strength.

The adhesive strength of the adhesive material may be controlled based on the change in the degree of polymerization of the adhesive material by heating, but according to this method, it may be difficult to form a structure having a partially different adhesive strength. In order to form a structure having a partially different adhesive strength, it is desirable that the entire surface of the adhesive material is so controlled that it may have a sufficient adhesive strength in order that the plastic substrate applied thereto may not peel off throughout the process, and thereafter, using a mask, for example, the adhesive strength of only the necessary part of the adhesive material layer is reduced. For reducing the adhesive strength, preferred is oxygen plasma treatment, ozone treatment or UV ray irradiation treatment. One or more these methods may be used either singly or as combined in any desired manner to control adhesive strength.

In general, a thin-film laminate device is formed in the center part of a plastic substrate, it is necessary that the peripheral part of the fixing component shall have a high adhesive strength to such a degree that the plastic substrate fitted on it does not undergo film delamination throughout the entire process of device formation. In device formation, when the heating temperature is lower, then the adhesive strength may be lower; but when a device having higher device performance is to be produced, then the temperature in the heating step must be from 200° C. to 250° C. or so, and in order to prevent the film delamination of the plastic substrate under such condition, the adhesive strength must be at least 0.5 newtons or more. On the other hand, the center part of the plastic substrate in which a device is formed must be cut off from the peripheral part of the plastic substrate after the device formation thereon and the plastic substrate with the formed device thereon must be peeled from the fixing component, and in that condition, the center part of the fixing component must have a lower adhesive strength than that of the peripheral part of the fixing component in order that the plastic substrate may be smoothly peeled off not detracting from the properties of the device owing to the tensile stress to be given to the device in its peeling. In this case, when the adhesive strength is lower, then the deterioration of the device properties in peeling the device may be reduced; but when the adhesive strength is zero, then the plastic substrate may be readily deformed and locally roughened in the device formation step, especially in a high-temperature processing step therefore having a serious influence on the properties of the formed device. Accordingly, though depending on the adhesive strength of the peripheral part thereof, it is desirable that the center part of the fixing component has a limited adhesive strength. For these reasons, the adhesive strength of the peripheral part of the fixing component is preferably at least 0.5 newtons, and the adhesive strength of the center part thereof is preferably at most 0.4 newtons. Also preferably, the difference in the adhesive strength between the two regions is at least 0.2 newtons, more preferably at least 0.5 newtons, even more preferably at least 1.0 newton.

In the second step, the adhesive material layer is so processed that it may have at least a low adhesive strength region and a high adhesive strength region of which the adhesive strength is higher than that of the low adhesive strength region, and apart from these, the layer may have one or more other regions having a different adhesive strength. For example, in the above-mentioned embodiment, a region having a further higher adhesive strength than that of the high adhesive strength region may be formed in addition to the low adhesive strength region of the center part and the high adhesive strength region of the peripheral part; or a region having a further lower adhesive strength than that of the low adhesive strength region may be formed; or a region having an intermediate adhesive strength between the high adhesive strength region and the low adhesive strength region may be formed. These regions may be formed, for example, in the high adhesive strength region of the peripheral part. Preferred in view of the production costs is an embodiment that comprises forming two regions of a high adhesive strength region and a low adhesive strength region in the second step.

### Third Step:

In the method of fixing a plastic substrate of the invention, the third step comprises applying under pressure a plastic substrate to the adhesive material layer having the plural adhesive strength regions provided therein, in an atmosphere having a vacuum degree of at most 300 Torr.

In case where a plastic substrate is fitted to a fixing component in air, when the resulting structure takes bubbles therein, then the bubbles may expand in a high-temperature processing process or in a vacuum processing step in the device formation process, therefore causing film delamination or surface roughening. When the plastic substrate is fitted to the fixing component with giving a high power thereto for preventing air bubbles from being caught by the device structure, the surface of the plastic substrate may be readily scratched. For these reasons, for preventing introduction of bubbles thereinto, it is desirable that the fixing component and the plastic substrate are bonded to each other under pressure in vacuum. The vacuum degree in bonding the plastic substrate to the fixing component is preferably at most 300 Torr, more preferably at most 30 Torr, even more preferably at most 1 Torr.

Generally in most cases, a plastic substrate and an adhesive material contain water and organic solvent. Even through they are bonded under such condition, water and organic solvent may be gradually evaporated away in a high-temperature processing step or a vacuum processing step in the process of device formation and the vapor may stay in the bonded interface to give bubbles. Accordingly, it is desirable that the plastic substrate and the adhesive material are processed in a vacuum heating step in which they are durable, for the purpose of fully removing water and organic solvent from them before used for lamination.

In the third step, a plastic substrate is applied under pressure to the fixing component in order that it may adhere to the two regions including at least the high adhesive strength region and the low adhesive strength region of the fixing component. In general, an adhesive material layer that corresponds to the size of the plastic substrate is formed in the first and second steps; and in the third step, the plastic substrate is applied under pressure to the adhesive material layer. In the invention, a plurality of units each containing two regions including at least a high adhesive strength region and a low adhesive strength region are formed on a supporting substrate and then a plastic substrate is applied under pressure to each unit. In this step, the unit and the plastic substrate to correspond to it may have the same size or a different size.

### Fourth Step:

The fixed plastic substrate produced according to the process of the above first to third steps may be further processed in a fourth step and a fifth step, thereby producing a circuit substrate. In the method for producing a circuit substrate of the invention, the fourth step comprises forming a circuit in a region of the surface of the plastic substrate opposite to the face thereof adhered to the adhesive material layer and corresponding to the area just above the low adhesive strength region.

For convenience sake, the face of the plastic substrate having an adhesive material layer formed thereon is referred to as a lower face; and the face opposite to it is referred to as an upper face. A circuit is formed on the upper face. Precisely, the circuit is formed in the region of the upper face corresponding to the area just above the low adhesive strength region. That is, the circuit is formed in the upper face region that corresponds to the back of the lower face region adhered to the low adhesive strength region.

In the fourth step, any ordinary process used in producing ordinary circuit substrates may be suitably employed herein. In forming a thin-film laminate device, in general, a vacuum film formation device for CVD, sputtering, vapor deposition may be used continuously for forming and laminating the constitutive thin-film layers. For example, an amorphous silicon TFT may be formed as follows: An active layer of amorphous silicon is formed through CVD by applying a mixed gas of silane gas and hydrogen gas onto a heated substrate in a reduced-pressure condition. In this step, the reduced-pressure condition is generally on an order of at most 10⁻¹ Torr. The heating temperature may be 150° C. or higher. In the invention, a heat-resistant plastic substrate that is durable to the heating temperature is selected and used. In the invention, even when a reduced-pressure condition of an order of at most 10⁻¹ Torr and a temperature condition of 150° C. or higher are employed, the plastic substrate may be prevented from being roughened and peeled owing to expansion of bubbles around it, since the third step prevents introduction of bubbles.

### Fifth Step:

In the method for producing a circuit substrate of the invention, the fifth step comprises cutting out the region of the plastic substrate having the circuit formed thereon, as released from the low adhesive strength region of the adhesive material layer serving as a release layer, thereby producing a circuit substrate having a circuit on the plastic substrate.

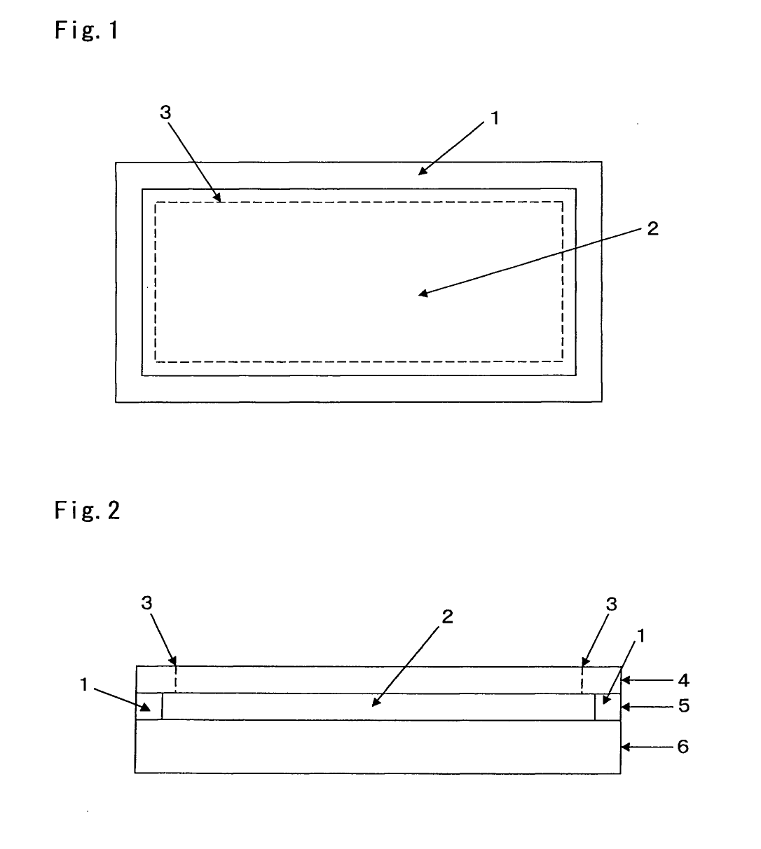

In this step, the plastic substrate is cut out in the region where it adheres to the low adhesive strength region. For example, in an embodiment having a low adhesive strength region 2 in a center part and having a high adhesive strength region 3 in a peripheral part, as in FIG. 1 and FIG. 2, a circuit is formed within the dotted line region in FIG. 1 and the plastic substrate 4 is cut out along the dotted line according to the fifth step. In this embodiment, in the separably-cut, dotted line region, the plastic substrate is bonded to the supporting substrate 6 only via the low adhesive strength region 2, and therefore the circuit-formed plastic substrate may be released from the fixing component by a relatively weak force given thereto. The cutting method is not specifically defined, for which, for example, employable is a cutter or a laser.

The characteristics of the invention are described more concretely with reference to the following Examples, in which the material used, its amount and the ratio, the details of the treatment and the treatment process may be suitably modified or changed not overstepping the sprit and the scope of the invention. Accordingly, the invention should not be limitatively interpreted by the Examples mentioned below.

### EXAMPLE 1

### (A) Fixing Component Forming Step:

A silicone rubber monomer (Shin-etsu Chemical Industry's X-34-632T-A and B mixture) was applied onto a supporting substrate of glass (30 cm×50 cm, thickness 1 cm), and then gradually heated from room temperature up to 150° C. and heated in an electric oven for an hour, thereby polymerizing the silicone rubber. The thickness of the adhesive material layer thus formed on the supporting substrate was 300 μm, and the adhesive strength thereof was 6 newtons (N).

### (B) Adhesive Strength Controlling Step:

Next, a metal mask was put on the adhesive material layer, and introduced into a dry-etching device, in which this was subjected to oxygen plasma treatment. The opening of the metal mask used herein was 24 cm×40 cm, and the mask was so set that its opening could be in the center of the supporting substrate of glass. The oxygen plasma treatment condition was as follows: The oxygen flow rate was 50 sccm, the pressure was 0.5 Torr, the power was 300 W, and the time was 10 minutes. After the oxygen plasma treatment, the mask was peeled off, and the adhesive strength of the peripheral region on which the mask was put and the adhesive strength of the center part that had been exposed to oxygen plasma were measured, and they were 6 newtons (N) and 0.1 newtons (N), respectively.

### (C) Plastic Substrate Fixing Step:

A polyimide substrate coated with a 500-nm silicon nitride film on both surfaces thereof and having a thickness of 50 μm was fixed to the supporting substrate in a vacuum thermal bonding device. For bonding them, the two were kept under a pressure of 100 kilonewtons for 1 minute in a vacuum having a vacuum degree of 0.2 Torr (this is hereinunder referred to as a fixing substrate 1). The adhesion between the plastic substrate and the supporting substrate was good with no visible bubbles existing therein.

### (D) Device Forming Step:

On the plastic substrate, an amorphous silicon TFT, a type of a thin-film laminate device, was formed according to a process mentioned below.

The fixing substrate 1 was put into a sputtering device, and degassed until the vacuum degree in the device could reach 4×10⁻⁵ Torr. With that, a thin chromium film was formed on it, having a controlled thickness of 300 nm. This was used as a gate electrode, for which a predetermined electrode pattern was formed according to a photoresist-processing method (comprising resist film formation, prebaking, exposure to light, development, postbaking, etching, resist removal, washing, and drying). Next, this was put into a film-forming chamber of a plasma CVD device, degassed while kept at 200° C., and then silane gas and ammonia gas were introduced thereinto for depositing a thin silicon nitride film on it. The film-forming condition was as follows: The silane gas flow rate was 5 sccm, the ammonia gas flow rate was 20 sccm, and the vacuum degree during film formation was 0.5 Torr, the power was 30 W, and the time for film formation was 30 minutes.

Next, this was moved into a different film-forming chamber of the same device, degassed while kept at 200° C., then silane gas and hydrogen gas were introduced thereinto and a thin amorphous silicon film was laminated on it. The film-forming condition was as follows: The silane gas flow rate was 2.5 sccm, the hydrogen gas flow rate was 30 sccm, and the vacuum degree during film formation was 0.5 Torr, the power was 8 W, and the time for film formation was 50 minutes.

Next, this was rapidly taken out of the plasma CVD device and led into a resistance-heating vapor deposition device, in which a 300-nm thin aluminium film was formed on it. The thus-obtained laminate film was repeatedly processed according to the above-mentioned photoresist-processing process, thereby forming it into a final TFT, and then, using a cutter, the plastic substrate was cut out in the low adhesive strength region to obtain an amorphous silicon TFT formed on the plastic substrate (device 1).

In the entire process of forming the amorphous silicon TFT, there occurred no trouble of plastic substrate peeling or surface roughening owing to introduction of bubbles.

### (E) Determination of TFT Properties:

Using Agilent's semiconductor parameter analyzer, 4156C and Vectorsemicon's semiautomatic prober AX-2000, the TFT properties were determined. As a result, the field mobility of the device 1 was 0.5 cm²/Vs.

### EXAMPLE 2

In (A) of Example 1, a double-face adhesive tape of silicone-based adhesive (Teraoka Seisakusho's 760H#25) was applied to the supporting substrate of glass, in place of using the silicone rubber monomer. In this step, the double-face adhesive, from which the protective film on one surface had been removed, was stuck to the supporting substrate of glass. For bonding the two, the same vacuum thermal bonding device as in Example 1(C) was used under the same condition as therein. After thus bonded, this was taken out of the device, and the protective film on the other surface was removed. The adhesive strength of the supporting substrate was 8.8 newtons. Next, a metal mask was put on the adhesive material layer under the same condition as in Example 1(B), and put into a dry etching device, in which this was subjected to oxygen plasma treatment. The adhesive strength of the peripheral region on which the mask was put and the adhesive strength of the center part that had been exposed to oxygen plasma were measured, and they were 8.8 newtons and 0.4 newtons, respectively.

In the same manner as in (C) and (D) of Example 1, the substrate was processed to produce an amorphous silicon TFT (device 2). In the same manner as in (E) of Example 1, the TFT properties of the device 2 were determined. As a result, the field mobility was 0.5 cm²/Vs.

### COMPARATIVE EXAMPLE 1

An amorphous silicon TFT was fabricated in the same manner as in Example 1, for which, however, the adhesive material controlling step (B) was omitted (device 3). The adhesive strength of the adhesive material before bonding to the plastic substrate was the same both in the peripheral part and in the center part thereof, and was 6 newtons. However, in the final step of peeling the plastic substrate, it could not be peeled off with ease since its adhesive strength was too high. When the peeling force was increased so as to peel the substrate, then the TFT peeled away from the plastic substrate, and, after all, the electric properties of the TFT could not be determined.

### COMPARATIVE EXAMPLE 2

Fabricating an amorphous silicon TFT was dried in the same manner as in Example 1, for which, however, the metal mask was not used in the adhesive material controlling step (B) but the entire surface of the substrate was exposed to oxygen plasma treatment (device 4). The adhesive strength of the adhesive material before bonding to the plastic substrate was the same both in the peripheral part and in the center part thereof, and was 0.1 newton. The adhesiveness between the plastic substrate and the supporting substrate was good with no visible bubbles existing therebetween. However, in the step of forming a thin silicon nitride film through CVD, the plastic substrate peeled off from the supporting substrate 6, and therefore the sample could not be further processed in the subsequent steps.

### COMPARATIVE EXAMPLE 3

An amorphous silicon TFT was fabricated in the same manner as in Example 1, for which, however, the substrates were bonded in air in the plastic substrate fixing step (C) (device 5). After the oxygen plasma treatment, the mask was removed, and the adhesive strength of the peripheral region on which the mask was put, and the adhesive strength of the center part that had been exposed to oxygen plasma were measured, and they were 6 newtons (N) and 0.1 newtons (N), respectively. The adhesiveness between the plastic substrate and the supporting substrate was good with no visible bubbles existing therebetween. However, in the step of forming a thin silicon nitride film through CVD, the plastic substrate peeled off from the supporting substrate 6, and therefore the sample could not be further processed in the subsequent steps.

The above results are all shown in Table 1.

TABLE 1

| | | Adhesive Strength | | | | |
|---|---|---|---|---|---|---|
| | | (newton) | | | Condition of Plastic | |
| | | peripheral | center | Vacuum Degree in | Substrate and Device | Field Mobility |
| | Device | part | part | Bonding (Torr) | in Process | of TFT (cm²/Vs) |
| Example 1 | device 1 | 6 | 0.1 | 0.2 | good | 0.5 |
| Example 2 | device 2 | 8.8 | 0.4 | 0.2 | good | 0.5 |
| Comparative | device 3 | 6 | 6 | 0.2 | device broken during | not detected |
| Example 1 | | | | | peeling | |
| Comparative | device 4 | 0.1 | 0.1 | 0.2 | plastic substrate | not detected |
| Example 2 | | | | | peeled | |
| Comparative | device 5 | 6 | 0.1 | 760 (atmospheric | plastic substrate | not detected |
| Example 3 | | | | pressure) | peeled | |

According to the invention, even a plastic substrate of which the strength and the toughness are poor by itself may be used in producing a thin-film laminate device. In addition, according to the invention, a circuit substrate may be produced smoothly with no trouble of film delamination or deterioration of device properties throughout the entire process of producing it. Further, the invention has made it possible to produce a high-performance thin-film laminate device in a high-temperature and high-vacuum process. Accordingly, the industrial applicability of the invention is good.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 075975/2006 filed on Mar. 20, 2006, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A method for fixing a plastic substrate, comprising:
applying or sticking an adhesive material onto a supporting substrate to thereby form an adhesive material layer on the supporting substrate (first step),
applying selective adhesive strength controlling treatment to the adhesive material layer to thereby form, in the adhesive material layer, at least two regions of a low adhesive strength region and a high adhesive strength region of which the adhesive strength is higher than that of the low adhesive strength region (second step), and
applying under pressure a plastic substrate to the adhesive material layer having the plural adhesive strength regions provided therein, in an atmosphere having a vacuum degree of at most 300 Torr (third step).

2. The method for fixing a plastic substrate as claimed in claim 1, wherein the adhesive strength of the low adhesive strength region is from 0.01 to 0.4 newtons.

3. The method for fixing a plastic substrate as claimed in claim 1, wherein the adhesive strength of the high adhesive strength region is at least 0.5 newtons.

4. The method for fixing a plastic substrate as claimed in claim 1, wherein the adhesive strength controlling treatment in the second step is at least one selected from a group consisting of oxygen plasma treatment, ozone treatment and UV ray irradiation treatment.

5. The method for fixing a plastic substrate as claimed in claim 1, wherein the high adhesive strength region is disposed in the peripheral region of the supporting substrate.

6. The method for fixing a plastic substrate as claimed in claim 1, wherein the low adhesive strength region is disposed in the center part except the peripheral region of the supporting substrate.

7. The method for fixing a plastic substrate as claimed in claim 1, wherein the vacuum degree in the third step is at most 30 Torr.

8. A fixed plastic substrate produced by the method according to claim 1.

9. A method for producing a circuit substrate, comprising:
applying or sticking an adhesive material onto a supporting substrate to thereby form an adhesive material layer on the supporting substrate (first step),
applying selective adhesive strength controlling treatment to the adhesive material layer to thereby form, in the adhesive material layer, at least two regions of a low adhesive strength region and a high adhesive strength region of which the adhesive strength is higher than that of the low adhesive strength region (second step),
applying under pressure a plastic substrate to the adhesive material layer having the plural adhesive strength regions provided therein, in an atmosphere having a vacuum degree of at most 300 Torr (third step),
forming a circuit in a region of the surface of the plastic substrate opposite to the face thereof adhered to the adhesive material layer and corresponding to the area just above the low adhesive strength region (fourth step), and
cutting out the region of the plastic substrate having the circuit formed thereon, as released from the low adhesive strength region of the adhesive material layer serving as a release layer, thereby producing a circuit substrate having a circuit on the plastic substrate (fifth step).

10. A circuit substrate produced according to the method of claim 9.
